(19) United States
(12) Patent Application Publication
(10) Pub. No.: US 2024/0012961 A1
(43) Pub. Date: Jan. 11, 2024

(54) CLOUD-BASED ELECTRICAL GRID COMPONENT VALIDATION

(71) Applicant: X Development LLC, Mountain View, CA (US)

(72) Inventor: Hamed Khalilinia, San Mateo, CA (US)

(21) Appl. No.: 18/339,482

(22) Filed: Jun. 22, 2023

Related U.S. Application Data
(60) Provisional application No. 63/359,536, filed on Jul. 8, 2022.

(51) Int. Cl. G06F 30/20

(52) U.S. Cl. CPC G06F 30/20; G06F 2113/04

(57) ABSTRACT

Methods, systems, and apparatus, including medium-encoded computer program products, for cloud-based electrical grid component validation can include obtaining a computer model of an electric power grid. The computer model can include asset models for individual assets connected to the electric power grid. Each asset model can be configured to replicate operation of a corresponding type of physical electric grid asset. A first asset model can include a hardware emulator configured to execute firmware specific to the corresponding type of physical electric grid asset. Altered firmware for the first asset model can be received. The computer model can be processed using a simulation engine to obtain simulation results, and the simulation engine can be configured to simulate operation of the individual assets of the computer model including operation of the first asset model according to the altered firmware associated with the first asset model. Simulation results can be provided.

### CLAIM OF PRIORITY

This application claims priority under 35 USC § 119(e) to U.S. Patent Application Ser. No. 63/359,536, filed on Jul. 8, 2022, the entire contents of which are hereby incorporated by reference.

### BACKGROUND

Electrical systems include a broad range of interconnected components of various types such as inverters (Solar, Wind, HVDC, FACTS, etc.), relays, Power Plant Controllers (PPCs), Energy Management Systems, Remedial Action Systems (RAS), Automatic Generator Controls, alarm systems and so on.

### SUMMARY

This specification relates to cloud-based validation of components of an electrical system. The validation uses hardware emulators configured to run component firmware. The validation techniques can include simulations of assets within the electrical system, where the asset simulations use models of the assets to simulate the behavior of electrical power grid elements. Asset models can include firmware specific to a type of asset, and hardware emulators can be configured to run component firmware. The system can receive alterations to the firmware, and validate components of the electrical system by simulating the electrical system using the altered firmware.

Particular embodiments of the subject matter described in this specification can be implemented so as to realize one or more of the following advantages. The techniques described below can be used to simulate the results of altering the firmware for components of an electric grid, which can reduce the likelihood of firmware defects causing errors in the grid. The techniques further enable simulation without requiring the distribution of the hardware components, which can reduce cost and the chance that a malicious party will reverse engineer the hardware components. In addition, the techniques allow users to perform simulations of various combinations of firmware updates applied to multiple components of the system in various combinations. Such robust simulation can further reduce the likelihood that errors related to firmware updates are introduced into actual hardware assets installed in electric power systems.

One aspect features obtaining a computer model of an electric power grid. The computer model can include asset models for individual assets connected to the electric power grid. Each asset model can be configured to replicate operation of a corresponding type of physical electric grid asset. A first asset model of the asset models can include a hardware emulator configured to execute firmware specific to the corresponding type of physical electric grid asset. An asset interface can be provided that is configured to permit a user to alter the first asset model. Altered firmware for the first asset model can be received through the asset interface and from a user. The computer model can be processed using a simulation engine to obtain simulation results, and the simulation engine can be configured to simulate operation of the individual assets of the computer model including operation of the first asset model according to the altered firmware associated with the first asset model. Simulation results indicating how the first asset model functioned while using the altered firmware can be provided for display to the user. Other implementations of this aspect include corresponding systems, apparatus, and computer programs, configured to perform the actions of the methods, encoded on computer storage devices.

One or more of the following features can be included. In response to determining that the simulation results satisfy validation criteria, the altered firmware can be determined to be valid. The altered firmware can include a replacement for the firmware. The altered firmware can include a configuration setting for the firmware. The asset interface can be configured to permit a user to alter a second asset model, and can further include receiving, through the asset interface and from the user, second altered firmware for the second asset model. The computer model can be processed using the simulation engine to obtain simulation results, the simulation engine configured to simulate operation of the individual assets of the computer model including (i) operation of the first asset model according to the altered firmware associated with the first asset model, and (ii) operation of the second asset model according to the second altered firmware associated with the second asset model. A specification of the altered firmware can be determined to satisfy a specification of an asset described by the asset model, and the altered firmware can be applied to the asset. The specification of the asset can include a type, a make or a version of the asset. In response to determining that the simulation results satisfy acceptance criteria, an operation can be performed. The operation can include updating the computer model of the electric power grid. The operation can include providing to a user a notification indicating that the simulation was successful. Simulating operation of the individual assets of the computer model can include executing firmware. Executing firmware can include accepting an input and performing an operations using the firmware on the input to produce a result that simulates the result the firmware would produce when running on physical hardware and executing on the same input. Processing the computer model can include executing the simulation engine on the computer model in a sandbox environment.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 shows an example environment for cloud-based electrical grid component validation.

FIG. 2 is a flow diagram of an example process for cloud-based electrical grid component validation.

FIG. 3 is a block diagram of an example computer system.

### DETAILED DESCRIPTION

Electrical systems include a broad range of interconnected components of various types such as inverters (Solar, Wind, HVDC, FACTS, etc.), relays, Power Plant Controllers (PPCs), Energy Management Systems, Remedial Action Systems (RAS), Automatic Generator Controls, alarm systems and so on. The operation of one component can influence the operation of other components. For example, a PPC regulates and controls networked inverters within a power plant. Therefore, when a change is planned for one component, it is important to test the modified version of the component in an environment that includes the other connected element to ensure that the change does not produce deleterious effects anywhere in the system. To avoid potentially catastrophic failure, only after thorough testing is complete should the update be deployed to the production environment.

The operation of many components is controlled, in part, by firmware, which is software that provides low-level control for the component's specific hardware. Firmware can be updated to enable new hardware capability and to address any defects detected in a firmware version. However, as described above, to reduce the likelihood that a defect in the firmware causes a fault anywhere in the system, before firmware updates are deployed, the updates should be tested in an environment that simulates the overall production environment.

One approach to such testing is called “hardware in the loop” (HIL) simulation. With HIL simulation, the environment is simulated by adding a mathematical representation, called the “plant simulations,” for all relevant components of the environment. The component under test is connected to a HIL simulator that provides electrical emulation of sensors and actuators. These electrical emulations act as the interface between the plant simulation and the component under test. The value of each electrically emulated sensor is controlled by the plant simulation and is read by the embedded system under test.

However, several drawbacks to HIL systems exist. First, the simulators are specific to individual electrical components, and if a simulator does not exist for a particular component, HIL cannot be used. Second, an HIL simulator is loaded with mathematical representations of other components in the environment, and when those components are updated (e.g., the component firmware is updated), the HIL simulator can become out of date. Third, the HIL simulators are physically large, which can impede their use in real-world deployments.

This specification describes techniques for Cloud-based electrical grid component validation, also called “firmware-in-the-loop in the Cloud” (FILIC). A validation system that performs the techniques of this specification can include a Cloud-based validation engine that includes a grid model that simulates the overall structure of the electric grid. The grid model can contain asset models for each type of electrical component in the relevant environment.

By providing FILIC, the techniques described in this specification allow firmware developers to test firmware updates in the context of a grid model without requiring the presence of expense hardware, such as HIL systems. In addition, in contrast to conventional techniques where firmware updates are tested against one version of firmware for each of the other grid components, the techniques of this specification enable simulations when multiple electrical components simultaneously apply firmware updates.

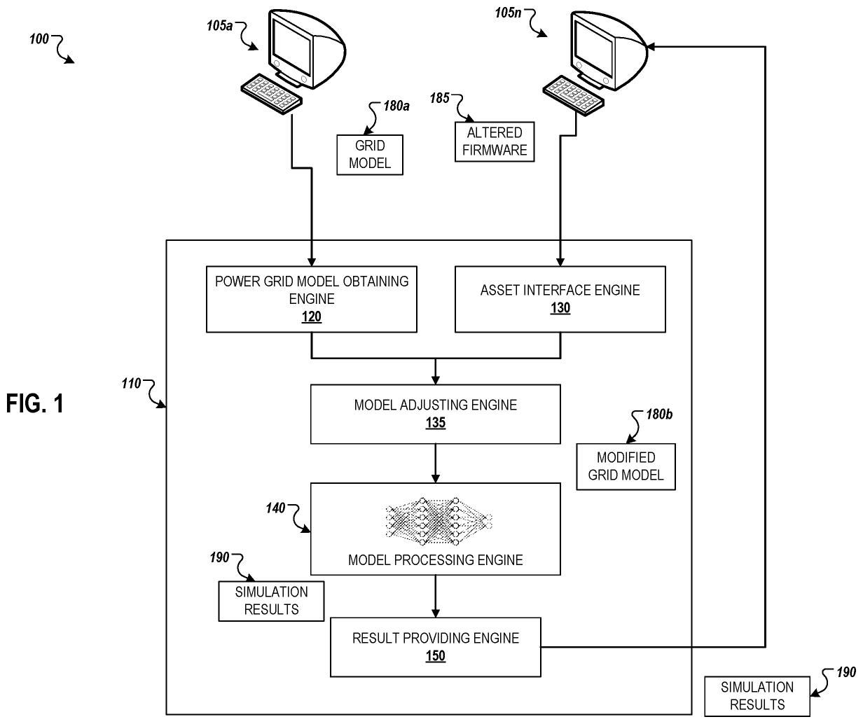

FIG. 1 shows an example environment for cloud-based electrical grid component validation. The environment can include an electrical grid component validation system 110 and one or more client devices 105a, 105n (collectively referred to as 105).

The electrical grid component validation system 110 can include a power grid model obtaining engine 120, an asset interface engine 130, a model adjusting engine 135, a model processing engine 140 and a result providing engine 150. The electrical grid component validation system 110 can reside on one or more computer servers that can reside at a single location or can be geographically distributed and connected by a network such as the Internet or an intranet. For example, the electrical grid component validation system 110 can run on a Cloud platform. A Cloud platform can include computing resources such as servers, storage, databases, networking, and can reside in a single datacenter or can be spread across multiple datacenters that are connection via a network such as the Internet or an intranet, which can be geographically distant.

The power grid model obtaining engine 120 can obtain a model 180a of a power grid (“grid model,” for brevity). The power grid model obtaining engine 120 can include an Application Programming Interface (API) that allows users of the system 110 to provide a grid model 180a or a location of the model. In some implementations, the API can accept Uniform Resource Indicators (URIs) that specify the location of a grid model 180a. The power grid model obtaining engine 120 can use the URI to retrieve the model 180a. In some implementations, the power grid model obtaining engine 120 accesses a grid model 180a from a database. For example, a common model of an electric grid can be used for a many users of the system 110. For example, the power grid model obtaining engine 120 can access a common electric grid model of a particular geographic region (e.g., California) for all users wishing to test firmware for different physical hardware assets connected the electric grid in that particular geographic region.

A grid model 180a, 180b (collectively referred to as 180) can include a plurality of asset models for individual assets connected to the electric power grid and a description of interconnections among the assets. Each asset model can be configured to replicate operation of a corresponding type of physical electric grid asset, and each asset model can be used to simulate the operation of an asset or a type of asset. An asset model can include a hardware emulator. The hardware emulator can be configured to execute firmware specific to the corresponding type of physical electric grid asset.

Executing firmware can include accepting an input and performing the operations specified by the firmware on the input to produce a result that simulates the result that the firmware would produce when running on physical hardware and executing on the same input. The input can be simulated input, such as data captured when operating an actual power grid, random data generated according to parameters encountered in an actual grid (e.g., voltage varying within some known parameters), data generated by a human operator and so on.

A grid model 180 of an electric power grid can be represented as a graph. Nodes of the graph can represent assets, and each node can include information about the asset such as an identifier, the type of asset, the make and version of the asset, the date of installation, information about service performed on the asset, etc. Edges in the graph can represent connections among assets, and can include an indication of the direction of the flow of power.

The asset interface engine 130 can receive altered firmware 185. Alterations can be of numerous types, including a replacement for the firmware, replacement of one or more components of the firmware, the addition or deletion of components of the firmware, changes to one or more firmware configuration settings, providing initial values for configuration settings, other firmware alterations, or any combination thereof. The altered firmware can include the type of alteration, a specific asset to which the alteration should be applied, a description of a class of assets to which the alteration should be applied (e.g., all transformers of a particular make and version), the alteration data (e.g., the firmware update, configuration setting, etc.) and other data relevant to an alteration. In some implementations, the asset interface engine 130 can include an API that allows users of the system 110 to provide altered firmware 185 or a location (e.g., a URI) of the altered firmware 185.

In some implementations, the asset interface engine 130 can provide user interface presentation data, which, when rendered by a client device 105, causes the client device 105 to render one or more user interface panels. Once a user has interacted with the user interface presentation data, the user interface presentation data can cause the client device 105 to transmit altered firmware 185, or a location of altered firmware 195, to the asset interface engine.

The model adjusting engine 135 can accept a grid model 180a and altered firmware 185 and produce a modified grid model 180b. In some implementations, the modified grid model 180b is the grid model 180a modified only by the altered firmware 185. The model adjusting engine can apply the altered firmware 185 to one or more assets in the grid model 180a to produce the modified grid model 180b, as described further below.

In some implementations, the model adjusting engine 135 can provide a “sandbox” in which the only change to the grid model is the altered firmware 185 submitted by a particular user. The altered firmware can be applied to one or more suitable components of the electrical grid model. For example, the altered firmware can be applied to a single component, to all components of a particular type (e.g., as defined by the make and model of the component), to a subset of the components of a particular type, and so on. Other components of the grid model remain unchanged. Providing a sandbox environment enables the system to simulate a particular firmware change while holding other components unchanged. In addition, by providing a sandbox, simulations run by one user is not impacted by the altered firmware 185 used in simulations by other users. For example, the grid model, or appropriate portion thereof, can be copied to a sandbox environment. The altered firmware can be applied to particular asset models of the copied grid model within the sandbox environment. A simulation can be executed on the copied grid model within the sandbox environment to simulate operation of the electric grid with the updated firmware applied to the particular asset models.

To enable the simultaneous update of multiple electrical components, in some implementations, the model adjusting engine 135 can apply multiple instances of firmware updates 185 to multiple electrical components. The system can accept the multiple firmware updates 185, and apply the updates to create the altered grid model 180b. For example, the model adjusting engine 135 can compare a specification associated with an asset type to a specification associated with a firmware update 185, as described further below.

In some implementation, the model adjusting engine 135 can provide to a user a list containing firmware updates that are available in addition to the firmware update 185. In response to receiving an indication of selected updates, the model adjusting engine 135 can apply the selected updates and the firmware update 185 to produce the modified grid model 135.

In some implementations, the model adjusting engine 135 can produce multiple updated grid models 185b. The model adjusting engine 135 can produce a first updated grid model 180b that differs from the grid model 180a only in the altered firmware 185. The model adjusting engine 135 can produce a second updated grid model 185b that contains the altered firmware 185 and other adjustments, e.g., as selected by a user. The mode adjustment engine 135 can provide the multiple modified grid models 185b to the model processing engine 140, which can perform multiple simulations, as described further below. Enabling multiple simulations using multiple altered grid models 180b enables a user to determine whether a firmware update 185 is compatible with firmware updates 185 proposed by other users, reducing the likelihood that multiple firmware updates will create grid defects. The system can produce altered grid models 180b for each candidate firmware update 185 that might be deployment during an update cycle.

The model processing engine 140 can evaluate the altered grid model 180b to produce simulation results 190 that indicated how the each asset model functioned while using the altered firmware 185. The model processing engine 140 can obtain or create simulated electrical inputs used by the simulation, as described above.

In some implementations, the simulation results 190 can include instantaneous values of electrical parameters (e.g., current, voltage, etc.) and the magnitude of electrical parameters at one or more points within the altered grid model 180b at one or more time periods. In some implementations, the simulation results 190 can include conditional values. For example, if the voltage at a particular asset satisfied a configured value, the simulation results 190 can include an indication such as the asset being highlighted in red. The simulation results 190 can also include an animation that illustrates the results of the simulation over time, audio indications that thresholds have been satisfied, and so on.

In varying implementations, the simulation results 190 can include results for various assets within the grid. In some implementations, the simulation results 190 can represent electrical parameters for one or more assets in the modified grid model 185b to which the firmware update 185 was applied. In some implementations, the simulation results 190 can represent electrical parameters of all asset within the modified grid model 185b. In some implementations, the simulation results 190 can represent electrical parameters for one or more assets within an identified region of the modified grid model 185b or for assets indicated by a user.

The simulation results 190 can be encoded in any appropriate data format. For example, the simulation results 190 can be encoded in XML where elements of the XML represent electrical points within altered grid model 185b and data for the electrical point, as described above (e.g., instantaneous values). The simulation results 190 can include elements for electrical points at one or more time periods.

The result providing engine 150 can provide, e.g., for display to the user, the simulation results 190. The simulation results 190 can be provided in the data format provided by the model processing engine 140, e.g., an XML format that can be displayed by a web browser. In some implementations, the result providing engine 150 can create user interface presentation data from the simulation results 190 and provide the user interface presentation data to a client device 105 for display.

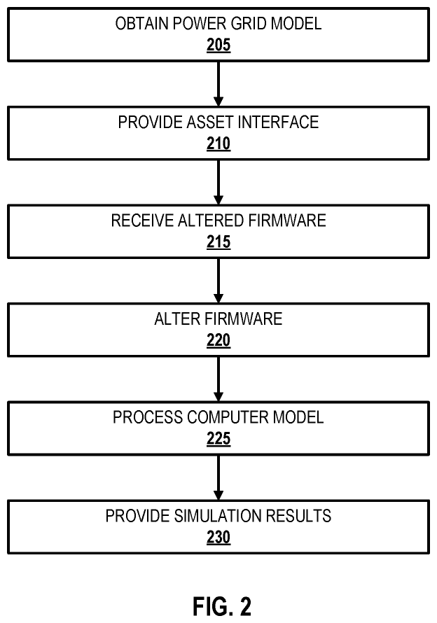

FIG. 2 is a flow diagram of an example process for cloud-based electrical grid component validation. For convenience, the process 200 will be described as being performed by a system for cloud-based electrical grid component validation, e.g., the cloud-based electrical grid component validation system of FIG. 1, appropriately programmed to perform the process. Operations of the process 200 can also be implemented as instructions stored on one or more computer readable media which may be non-transitory, and execution of the instructions by one or more data processing apparatus can cause the one or more data processing apparatus to perform the operations of the process 200. One or more other components described herein can perform the operations of the process 200.

The system can obtain (205) a power grid model. The system can provide an API that is configured to accept URIs that specify the location of a power model. Upon receiving the URI, the system can use conventional web networking protocols (e.g., Hypertext Transfer Protocol (HTTP) or HTTP-Secure (HTTP-S)) to retrieve the power grid model from the location specified by the URI.

The system can provide (210) an asset interface that is configured to permit a user to alter an asset model. As described above, in some implementations, the system can provide an asset interface that provides user interface presentation data that enables a user to alter an asset model. In some implementations, the system can provide an asset interface, such as a web interface, that accepts alterations to an asset model.

The system can receive (215) altered firmware. In some implementations, the system can provide user interface presentation data that, when rendered by a client device (e.g., by a web browser executing on a laptop or desktop computer), allows the user to specify the location of the updated firmware, and to indicate that the firmware requires update. The system can then retrieve the updated firmware from that location and load it into the corresponding model, replacing the existing firmware. In some implementations, the system can provide user interface presentation data that, when rendered by a client device, allows a user to provide firmware (e.g., using Hypertext Transfer Protocol) associated with a particular asset model to the system. In some implementations, the system can provide user interface presentation data that, when rendered by a client device, allows a user to specify firmware settings associated with a particular asset model. In some implementations, the system can provide an application programming interface (API), which can be invoked by a client (user or another program) that supplies updated firmware directed to an asset type or specific asset present in the environment.

In some implementations, the system can receive multiple instances of altered firmware. Instances of altered firmware can be associated with different asset models, and/or multiple instances of altered firmware can be associated with one asset model. For example, one instance of altered firmware can be associated with a first asset model, and a second instance of altered firmware can be associated with a second, different asset model. In other example, one instance of altered firmware can include a component to be included in the firmware for one asset model, and a second instance of altered firmware can include configuration settings for the firmware for that asset model.

Once received, the system can alter (220) the firmware for at least one asset model in the grid model. The system can first determine the asset(s) in the grid model to which the firmware alteration (or alterations) applies by comparing the specification of the firmware alteration to the specification of the assets in the grid model. The system can first identify any assets in the grid model with an identification specified by the firmware alteration. The system can further identify any assets in the grid model with specifications that satisfy the specifications in the firmware alteration. For example, if a firmware alteration specifies an asset type, asset make and asset version, the system can identify all assets in the grid model with the specified asset type, make and version. In another example, if a firmware alteration specifies an asset type and asset make, the system can identify all assets in the grid model with the specified asset type and make. In some implementations, the firmware alteration can include a more complex specification (e.g., a regular expression) that identifies assets within a grid model. In such implementations, the system can evaluate the specification to determine the relevant assets. The system can determine the assets relevant to all firmware alterations received in operation 215.

Once the system has identified the assets, the system can apply the modified firmware. As described above, the modified firmware can include an indication of the type of modification (e.g., change to a setting, replace the firmware, etc.). The system can determine the modification type and perform the appropriate modification. For example, if a firmware configuration setting is set or changed, the system can set or change the setting; if a component of the firmware is to be replaced, the system can remove the original component from the firmware, and insert the new component; if the entire firmware is to be replaced; the system can remove the original firmware and insert the new firmware; and so on.

The system can process (225) the computer model using a simulation engine to obtain simulation results. The simulation engine can be configured to simulate the operation of the individual assets in the computer grid model using simulated electrical inputs. In some implementations, the system can obtain configured simulated electrical inputs from a storage device, e.g., by reading files that contain simulated electrical inputs. In some implementations, the system can generate simulated electrical inputs randomly or pseudo-randomly. In some implementations, the system can generate simulated electrical inputs randomly or pseudo-randomly that adhere to rules (e.g., a particular load must be between a minimum and maximum value) or to a configured distribution.

Once the asset models and simulated electrical inputs have been loaded, the system performs a simulation by processing the asset models using a simulation engine to obtain simulation results. The simulation results can be produced by evaluating one or more of the asset models against simulated input data. As describe above, asset models can include hardware emulators that can execute firmware designed for a particular asset or asset type. In response to receiving simulated electrical inputs, the hardware emulator can execute the firmware to produce a result, which can include a change in internal state of the simulated asset and an electrical output similar to how the physical asset would function.

As described above, the system can process the computer model on one or more grid models that include updated firmware. In some implementations, the system processes the computer models using a sandbox such that the simulation using one grid model is isolated from other simulations. In some implementations, the system can process the computer model using a grid model that includes all firmware updates. In some implementations, the system can process the computer model using grid models that include firmware updates applied in arbitrary combinations. For example, if the system has available three firmware updates, F1, F2 and F3, the system can process the computer model using F1 only; F1 and F2; F1 and F3; F2 and F3; and F1, F2 and F3; or any subset of the combinations. Each instance of processing the computer result can produce simulation results.

The system can provide (230) for display to the user simulation results indicating how an asset model functioned while using the firmware. The results can be included in user interface presentation data that, when rendered by a client device, causes the client device to display the simulation results. As described above, the simulation results can be provided by supplying or making available data that includes the simulation results, including user interface presentation data.

As further described above, the simulation results can include conditional values. Such conditional value can indicate whether the firmware update can be validated. For example, if the simulation results satisfy the conditions for all conditional values, the system can determine that the firmware update can be validated.

In some implementations, the system can update the grid model. The system can provide the simulation results, and in response to determining that the simulation satisfies acceptance criteria, the system can perform one or more operations. In some implementations the operations can include updating the grid model. The acceptance criteria can be a set of predicates (e.g., a value falls within an acceptable range) that, when satisfied, indicate that the updated firmware operated properly. The predicates can be combined by Boolean operations (AND, OR, NOT, NOR, etc.) to form complex predicates. In some implementations, in response to receiving from a user an indication that the simulation results were accepted, the system can update the grid model. In some implementations, the system can update the grid model when both the acceptance criteria are satisfied, and when a user provides an acceptance indicator.

The system can update the grid model, for example, by storing the updated grid model in a database. In some implementations, the system can replace the prior grid model in the database with the updated grid model. In some implementations, the system can add the updated grid model to the database, and store an indicator that the updated grid model is the current grid model.

In some implementations, in response to determining that the acceptance criteria are satisfied, the system can provide to a user a notification indicating that the simulation was successful. For example, the system can provide the notification by delivering a message using a conventional networking protocol (e.g., Transmission Control Protocol/Internet Protocol) or by providing user interface presentation data which, when rendered by a client device, displays a notification (e.g., a user interface message) that the simulation was successful.

While this specification has largely described an electrical network, the techniques can be applied to other network types. For example, a computing network can include components such as routers, switches, cellular towers, wireless access points and so on. Failures induced by firmware updates at one network element can result is cascading failures throughout the network. Similarly, an Internet of Things (IoT) network can include numerous devices that can include various sensor types (cameras, temperature sensors, barometers, Lidar, radar, among many others), actuators (e.g., to lock or unlock a door, trigger an alarm, activate a sensor, move a robotic device, etc.) and interconnecting networks. A defect introduced into one component (e.g., a faulty sensor that transmits excessive data) can result in failures throughout the network.

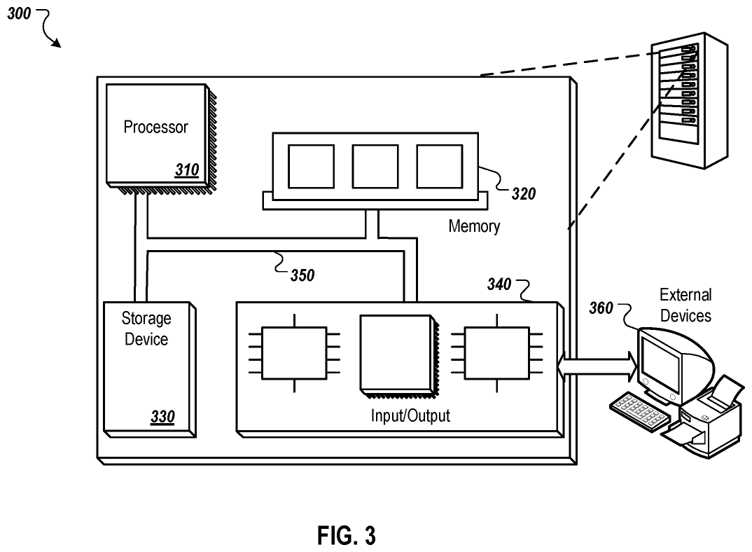

FIG. 3 is a block diagram of an example computer system 300 that can be used to perform operations described above. The system 300 includes a processor 310, a memory 320, a storage device 330, and an input/output device 340. Each of the components 310, 320, 330, and 340 can be interconnected, for example, using a system bus 350. The processor 310 is capable of processing instructions for execution within the system 300. In one implementation, the processor 310 is a single-threaded processor. In another implementation, the processor 310 is a multi-threaded processor. The processor 310 is capable of processing instructions stored in the memory 320 or on the storage device 330.

The memory 320 stores information within the system 300. In one implementation, the memory 320 is a computer-readable medium. In one implementation, the memory 320 is a volatile memory unit. In another implementation, the memory 320 is a non-volatile memory unit.

The storage device 330 is capable of providing mass storage for the system 300. In one implementation, the storage device 330 is a computer-readable medium. In various different implementations, the storage device 330 can include, for example, a hard disk device, an optical disk device, a storage device that is shared over a network by multiple computing devices (e.g., a cloud storage device), or some other large capacity storage device.

The input/output device 340 provides input/output operations for the system 300. In one implementation, the input/output device 340 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 360. Other implementations, however, can also be used, such as mobile computing devices, mobile communication devices, set-top box television client devices, etc.

Although an example processing system has been described in FIG. 3, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a computer-readable medium for execution by, or to control the operation of, data processing apparatus. The computer-readable medium can be a manufactured product, such as hard drive in a computer system or an optical disc sold through retail channels, or an embedded system. The computer-readable medium can be acquired separately and later encoded with the one or more modules of computer program instructions, such as by delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing and grid computing infrastructures.

A computer program (also known as a program, software, software application, script, or code) can be written in any suitable form of programming language, including compiled or interpreted languages, declarative or procedural languages, and it can be deployed in any suitable form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, special purpose microprocessors. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computing device capable of providing information to a user. The information can be provided to a user in any form of sensory format, including visual, auditory, tactile or a combination thereof. The computing device can be coupled to a display device, e.g., an LCD (liquid crystal display) display device, an OLED (organic light emitting diode) display device, another monitor, a head mounted display device, and the like, for displaying information to the user. The computing device can be coupled to an input device. The input device can include a touch screen, keyboard and a pointing device, e.g., a mouse or a trackball, by which the user can provide input to the computing device. Other kinds of devices can be used to provide for interaction with a user as well; for example, feedback provided to the user can be any suitable form of sensory feedback, e.g., visual feedback, auditory feedback, or tactile feedback; and input from the user can be received in any suitable form, including acoustic, speech, or tactile input.

The computing system can include clients and servers. A client and server are generally remote from each other and typically interact through a communication network. The relationship of client and server arises by virtue of computer programs running on the respective computers and having a client-server relationship to each other. Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any suitable form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many implementation details, these should not be construed as limitations on the scope of what is being or may be claimed, but rather as descriptions of features specific to particular embodiments of the disclosed subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Thus, unless explicitly stated otherwise, or unless the knowledge of one of ordinary skill in the art clearly indicates otherwise, any of the features of the embodiments described above can be combined with any of the other features of the embodiments described above.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and/or parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

What is claimed is:

1. An electrical grid asset validation method comprising:
obtaining a computer model of an electric power grid comprising a plurality of asset models for individual assets connected to the electric power grid, each asset model being configured to replicate operation of a corresponding type of physical electric grid asset, wherein a first asset model of the asset models includes a hardware emulator configured to execute firmware specific to the corresponding type of physical electric grid asset;
providing an asset interface configured to permit a user to alter the first asset model;
receiving, through the asset interface and from a user, altered firmware for the first asset model;
processing the computer model using a simulation engine to obtain simulation results, the simulation engine configured to simulate operation of the individual assets of the computer model including operation of the first asset model according to the altered firmware associated with the first asset model; and
providing, for display to the user, simulation results indicating how the first asset model functioned while using the altered firmware.

2. The electrical grid asset validation method of claim 1 further comprising:
in response to determining that the simulation results satisfy validation criteria, determine that the altered firmware is valid.

3. The electrical grid asset validation method of claim 1, wherein the altered firmware comprises a replacement for the firmware.

4. The electrical grid asset validation method of claim 1, wherein the altered firmware comprises a configuration setting for the firmware.

5. The electrical grid asset validation method of claim 1, wherein the asset interface is further configured to permit a user to alter a second asset model, further comprising:
receiving, through the asset interface and from the user, second altered firmware for the second asset model; and
processing the computer model using the simulation engine to obtain simulation results, the simulation engine configured to simulate operation of the individual assets of the computer model including (i) operation of the first asset model according to the altered firmware associated with the first asset model, and (ii) operation of the second asset model according to the second altered firmware associated with the second asset model.

6. The electrical grid asset validation method of claim 5, wherein processing the computer model comprises executing the simulation engine on the computer model in a sandbox environment.

7. The electrical grid asset validation method of claim 1 further comprising:
determining that a specification of the altered firmware satisfied a specification of an asset described by the asset model; and
applying the altered firmware to the asset.

8. The electrical grid asset validation method of claim 7, wherein the specification of the asset described by the asset model comprises a type, a make, or a version of the asset.

9. The electrical grid asset validation method of claim 1 further comprising:
in response to determining that the simulation results satisfy acceptance criteria, performing an operation.

10. The electrical grid asset validation method of claim 8, wherein the operation comprises updating the computer model of the electric power grid.

11. The electrical grid asset validation method of claim 8, wherein the operation comprises providing to a user a notification indicating that the simulation was successful.

12. The electrical grid asset validation method of claim 1, wherein simulating operation of the individual assets of the computer model comprises executing firmware.

13. The electrical grid asset validation method of claim 10, wherein executing firmware comprises:
accepting an input; and
performing an operations using the firmware on the input to produce a result that simulates the result the firmware would produce when running on physical hardware and executing on the same input.

14. A system comprising one or more computers and one or more storage devices storing instructions that when executed by the one or more computers cause the one or more computers to perform operations comprising:
obtaining a computer model of an electric power grid comprising a plurality of asset models for individual assets connected to the electric power grid, each asset model being configured to replicate operation of a corresponding type of physical electric grid asset, wherein a first asset model of the asset models includes a hardware emulator configured to execute firmware specific to the corresponding type of physical electric grid asset;
providing an asset interface configured to permit a user to alter the first asset model;
receiving, through the asset interface and from a user, altered firmware for the first asset model;
processing the computer model using a simulation engine to obtain simulation results, the simulation engine configured to simulate operation of the individual assets of the computer model including operation of the first asset model according to the altered firmware associated with the first asset model; and
providing, for display to the user, simulation results indicating how the first asset model functioned while using the altered firmware.

15. The system of claim 14, the operations further comprising:
in response to determining that the simulation results satisfy validation criteria, determine that the altered firmware is valid.

16. The system of claim 14, wherein the altered firmware comprises at least one of (i) a replacement, or (ii) a configuration for the firmware.

17. The system of claim 14, wherein the asset interface is further configured to permit a user to alter a second asset model, the operations further comprising:
receiving, through the asset interface and from the user, second altered firmware for the second asset model; and
processing the computer model using the simulation engine to obtain simulation results, the simulation engine configured to simulate operation of the individual assets of the computer model including (i) operation of the first asset model according to the altered firmware associated with the first asset model, and (ii) operation of the second asset model according to the second altered firmware associated with the second asset model.

18. A non-transitory computer-readable storage media storing instructions that when executed by one or more computers cause the one or more computers to perform operations comprising:
obtaining a computer model of an electric power grid comprising a plurality of asset models for individual assets connected to the electric power grid, each asset model being configured to replicate operation of a corresponding type of physical electric grid asset, wherein a first asset model of the asset models includes a hardware emulator configured to execute firmware specific to the corresponding type of physical electric grid asset;
providing an asset interface configured to permit a user to alter the first asset model;
receiving, through the asset interface and from a user, altered firmware for the first asset model;
processing the computer model using a simulation engine to obtain simulation results, the simulation engine configured to simulate operation of the individual assets of the computer model including operation of the first asset model according to the altered firmware associated with the first asset model; and
providing, for display to the user, simulation results indicating how the first asset model functioned while using the altered firmware.

19. The non-transitory computer-readable storage media of claim 18, the operations further comprising:
in response to determining that the simulation results satisfy validation criteria, determine that the altered firmware is valid.

20. The non-transitory computer-readable storage media of claim 18, wherein the asset interface is further configured to permit a user to alter a second asset model, the operations further comprising:
receiving, through the asset interface and from the user, second altered firmware for the second asset model; and
processing the computer model using the simulation engine to obtain simulation results, the simulation engine configured to simulate operation of the individual assets of the computer model including (i) operation of the first asset model according to the altered firmware associated with the first asset model, and (ii) operation of the second asset model according to the second altered firmware associated with the second asset model.
